(19) United States
(12) Patent Application Publication
(10) Pub. No.: US 2008/0231495 A1
(43) Pub. Date: Sep. 25, 2008

(54) MULTIPURPOSE PERIPHERAL DEVICE FOR RECEIVING SIGNALS

(75) Inventors: Jui-Hsiang Yang, Taipei (TW); Yuichiro Kuga, Taipei (TW); Kao-Yi Shen, Taipei (TW); Yung-Da Lin, Taiwan (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei Hsien (TW)

(21) Appl. No.: 11/692,272

(22) Filed: Mar. 28, 2007

(30) Foreign Application Priority Data
Feb. 27, 2007 (TW) 096203346

(51) Int. Cl. G01S 13/78

(52) U.S. Cl. 342/46

(57) ABSTRACT

A multipurpose peripheral device is operated with a portable electronic device. The portable electronic device includes a bus connection port. The multipurpose peripheral device includes a circuit carrier, at least two types of wireless signal-receiving/processing modules and a bus bridge module. The wireless signal-receiving/processing modules are disposed on the circuit carrier for receiving and processing corresponding wireless signals, thereby generating first signals and second signals. The bus bridge module is disposed on the circuit carrier and electrically connected to the wireless signal-receiving/processing modules and can be coupled to the bus connection port. The first signals and the second signals are transmitted from the wireless signal-receiving/processing modules to the portable electronic device through the bus bridge module and the bus connection port.

### FIELD OF THE INVENTION

The present invention relates to a multipurpose peripheral device, and more particularly to a multipurpose peripheral device operated with a portable electronic device and capable of receiving at least two types of wireless signals.

### BACKGROUND OF THE INVENTION

With increasing development of mobile computing technology industries, a variety of portable electronic devices such as notebook computers, personal digital assistants (PDAs) or mobile phones continues to make progress. Such development makes the electronic devices more important than before. Moreover, the users can operate these electronic devices in a more convenient manner.

Nowadays, many people may have experience in watching cable TV programs through personal computers. By externally wiring a TV box to the computer system or inserting a TV card complying with the specification of a peripheral component interconnect (PCI) interface or PCI Express (PCI-E) interface into a slot of the computer system and then communicating the TV card with a cable/wireless TV signal source, the user can watch TV programs through the personal computer, serving as a TV set.

Recently, instead of personal computers, more and more people have notebook computers on account of their portability and convenience. Hence, they may watch TV programs through notebook computers. Typically, the TV cards for use with the notebook computers conform to the specification of a PCMCIA standard interface, for example Cardbus TV cards, ExpressCard TV cards and the like. Alternatively, universal serial bus (USB) TV cards are also used with the notebook computers. Whereas, the TV cards applied to the PDAs include secure digital input/output (SDIO) cards or other I/O cards. By communicating a TV card and a cable/wireless TV signal source, the TV signals can be transmitted to the notebook computer or PDA in a wired or wireless transmission manner. As a consequence, in addition to portability, using the TV card to watch TV programs can also meet the “plug and play” requirements.

For example, a USB stick conforming to the specification of USB interface may be applied to a notebook computer. After the USB stick is plugged into a USB port of the notebook computer, the notebook computer may receive analog/digital TV signals in a wired or wireless transmission manner. As for the wireless transmission manner, a built-in antenna or an external antenna is required for receiving the wireless TV signals. Whereas, in the wired transmission manner, the USB stick needs to be communicated with a cable TV source. Accordingly, via the USB stick, the user can watch TV programs through the notebook computer.

With development of various digital electronic devices, many peripheral devices with particular functionalities are provided to be operated with the portable electronic devices. In addition to the above mentioned USB stick, more electronic devices and peripheral devices (also referred as USB devices) are designed to be accessible or controllable via the USB connection so as to be used with personal computers or notebook computers. As known, a general personal computer or notebook computer has a limited number of USB ports. At the same time, only a limited number of USB devices corresponding to the number of the USB ports are operable with the personal computer or notebook computer. Accordingly, the convenience and utility of these USB devices are adversely affected.

In views of the above-described disadvantages resulted from the prior art, the applicant keeps on carving unflaggingly to develop a multipurpose peripheral device according to the present invention through wholehearted experience and research.

### SUMMARY OF THE INVENTION

A multipurpose peripheral device operated with a portable electronic device is provided. The multipurpose peripheral device has at least two types of modules for receiving/processing at least two kinds of wireless signals, so that the limited USB ports of the portable electronic device are efficiently utilized.

In accordance with an aspect of the present invention, there is provided a multipurpose peripheral device operated with a portable electronic device. The portable electronic device has a bus connection port. The multipurpose peripheral device includes a circuit carrier, a GPS signal-processing module, a TV signal-processing module and a bus bridge module. The GPS signal-processing module is disposed on the circuit carrier for receiving and processing a GPS signal, thereby generating a first signal. The TV signal-processing module is disposed on the circuit carrier for receiving and processing a TV signal, thereby generating a second signal. The bus bridge module is disposed on the circuit carrier and electrically connected to the GPS signal-processing module, the TV signal-processing module and the bus connection port. The first signal and the second signal are transmitted to the portable electronic device through the bus bridge module and the bus connection port when they are coupled to each other.

Preferably, the portable electronic device is a notebook computer, a personal digital assistant or a smart phone.

In an embodiment, the bus connection port is a universal serial bus (USB) port, a peripheral component interconnect (PCI) port, a PCI Express (PCI-E) port or a secure digital input/output (SDIO) port.

In an embodiment, the multipurpose peripheral device further includes an antenna electrically connected to the GPS signal-processing module and the TV signal-processing module for receiving the GPS signal and the TV signal to be transmitted to the GPS signal-processing module and the TV signal-processing module, respectively.

In an embodiment, the GPS signal-processing module comprises a low noise amplifier for amplifying the GPS signal into an amplified GPS signal, a GPS tuner for tuning the amplified GPS signal into a tuned GPS signal, and a baseband demodulator for demodulating the tuned GPS signal, thereby generating the first signal.

In an embodiment, the GPS signal-processing module further includes a first antenna for receiving the GPS signal, and the TV signal-processing module further includes a second antenna for receiving the TV signal.

In an embodiment, the TV signal-processing module comprises a TV tuner for tuning the TV signal into a tuned TV signal, a TV demodulator for demodulating the tuned TV signal, thereby generating the second signal, and a TV decoder for performing demodulation and signal format conversion operation on the tuned TV signal, thereby generating the second signal.

In accordance with another aspect of the present invention, there is provided a multipurpose peripheral device operated with a portable electronic device. The portable electronic device has a bus connection port. The multipurpose peripheral device includes a circuit carrier, a wireless network module, a TV signal-processing module and a bus bridge module. The wireless network module is disposed on the circuit carrier for receiving and processing a network data signal, thereby generating a first signal. The TV signal-processing module is disposed on the circuit carrier for receiving and processing a TV signal, thereby generating a second signal. The bus bridge module is disposed on the circuit carrier and electrically connected to the wireless network module, the TV signal-processing module and the bus connection port. The first signal and the second signal are transmitted from the wireless network module and the TV signal-processing module to the portable electronic device through the bus bridge module and the bus connection port when they are coupled to each other.

In an embodiment, the multipurpose peripheral device further includes an antenna disposed on the circuit carrier for receiving the network data signal and the TV signal to be transmitted to the wireless network module and the TV signal-processing module, respectively.

In accordance with a further aspect of the present invention, there is provided a multipurpose peripheral device operated with a portable electronic device. The portable electronic device has a bus connection port. The multipurpose peripheral device includes a circuit carrier, a wireless network module, a GPS signal-processing module and a bus bridge module. The wireless network module is disposed on the circuit carrier for receiving and processing a network data signal, thereby generating a first signal. The GPS signal-processing module is disposed on the circuit carrier for receiving and processing a GPS signal, thereby generating a second signal. The bus bridge module is disposed on the circuit carrier and electrically connected to the wireless network module, the GPS signal-processing module and the bus connection port. The first signal and the second signal are transmitted from the wireless network module and the GPS signal-processing module to the portable electronic device through the bus bridge module and the bus connection port when they are coupled to each other.

In an embodiment, the multipurpose peripheral device further includes an antenna disposed on the circuit carrier for receiving the network data signal and the GPS signal to be transmitted to the wireless network module and the GPS signal-processing module, respectively.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a functional block diagram illustrating a multipurpose peripheral device operated with a portable electronic device according to a first preferred embodiment of the present invention;

FIG. 1B is a functional block diagram illustrating the GPS signal-processing module included in the multipurpose peripheral device of FIG. 1A;

FIG. 1C is a functional block diagram illustrating the TV signal-processing module included in the multipurpose peripheral device of FIG. 1A;

FIG. 2 is a functional block diagram illustrating a multipurpose peripheral device operated with a portable electronic device according to a second preferred embodiment of the present invention; and

FIG. 3 is a functional block diagram illustrating a multipurpose peripheral device operated with a portable electronic device according to a third preferred embodiment of the present invention.

### DETAILED DESCRIPTION OF THE PREFERRED EMBODIMENT

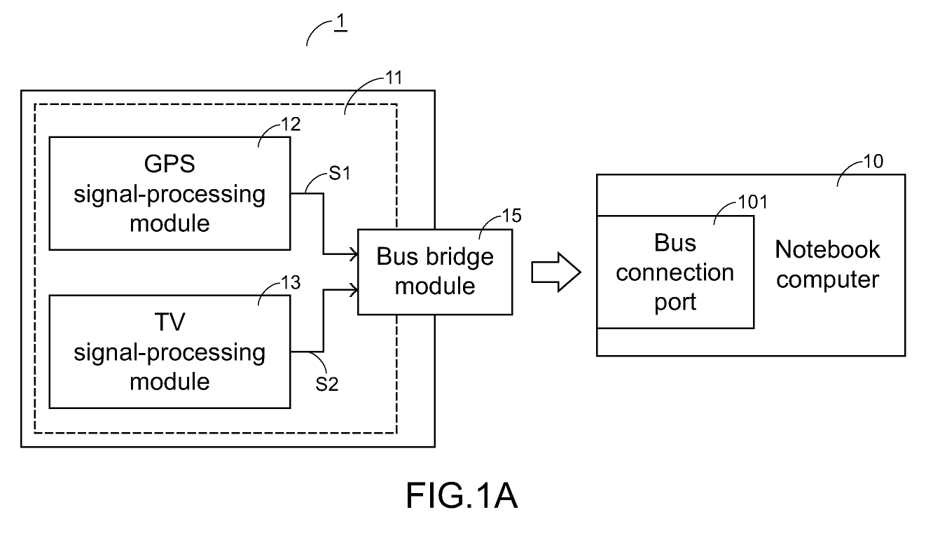

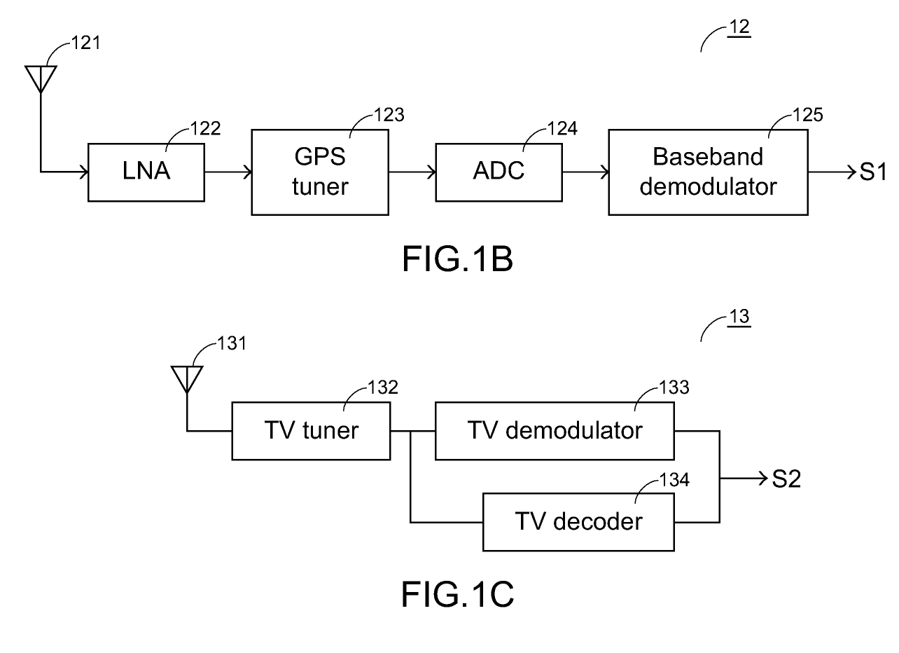

Referring to FIG. 1A, a functional block diagram of a multipurpose peripheral device operated with a portable electronic device according to a first preferred embodiment of the present invention is illustrated. As shown in FIG. 1A, an exemplary multipurpose peripheral device 1 is a USB device for receiving signals. In an embodiment, the portable electronic device is a notebook computer 10. The notebook computer 10 has a bus connection port 101, e.g. a USB port. After the multipurpose peripheral device 1 is coupled to the bus connection port 101 of the notebook computer 10, the multipurpose peripheral device 1 is operable with the notebook computer 10.

Two types of signal-processing modules are included in the multipurpose peripheral device 1 for receiving/processing signals. In the embodiment shown in FIG. 1A, these two signal-processing modules include a Global Positioning System (GPS) signal-processing module 12 and a TV signal-processing module 13 integrated into a circuit carrier 11 such as a circuit board. As a consequence, the multipurpose peripheral device 1 has functions of processing GPS signals and TV signals.

Furthermore, a bus bridge module 15 is also provided on the circuit carrier 11. The bus bridge module 15 is electrically connected to the GPS signal-processing module 12 and the TV signal-processing module 13. Via the bus bridge module 15, the multipurpose peripheral device 1 can be coupled to the bus connection port 101 of the notebook computer 10 in a hot plug manner. Under this circumstance, the GPS signals are received and processed by the GPS signal-processing module 12 to generate first signals S1, and the TV signals are received and processed by the TV signal-processing module 13 to generate second signals S2. These signals S1 and S2 are transmitted to the notebook computer 10 through the bus bridge module 15 and the bus connection port 101.

Referring to FIG. 1B, a functional block diagram of the GPS signal-processing module 12 is illustrated. The GPS signal-processing module 12 includes an antenna 121, a low noise amplifier (LNA) 122, a GPS tuner 123, an analog-to-digital converter (ADC) 124 and a baseband demodulator 125. The antenna 121 is employed to receive GPS signals from the GPS satellites. As known, the GPS signals need to be properly processed in order to provide very precise navigation information associated with position, direction and route. The GPS signals are amplified by the low noise amplifier 122, and then the amplified GPS signals are processed by the GPS tuner 123 which passes signals with one frequency or band of frequencies. The tuned signals are converted into digital signals by the analog-to-digital converter 124. Later, the digital signals are demodulated by the baseband demodulator 125, thereby generating the first signals S1 in a digital format. The first signals S1 are subsequently transmitted to the bus bridge module 15, thereby providing the precise navigation information.

In this embodiment, the analog-to-digital converter 124 is separated from the GPS tuner 123 and the baseband demodulator 125. Alternatively, the analog-to-digital converter 124 may be integrated into the GPS tuner 123 or the baseband demodulator 125. Also, in this embodiment, the baseband demodulator 125 is a hardware component disposed in the GPS signal-processing module 12. Alternatively, the baseband demodulator 125 may be withdrawn and the demodulating function thereof is implemented by associated software programs executed under the operating system of the rear-end notebook computer 10.

Referring to FIG. 1C, a functional block diagram of the TV signal-processing module 13 is illustrated. The TV signal-processing module 13 includes an antenna 131, a TV tuner 132, a TV demodulator 133 and a TV decoder 134. The antenna 121 is employed to receive wireless TV signals in a digital or analog format, which are issued from a wireless TV signal source. As known, the TV signals need to be further processed in order to be displayed through the notebook computer 10. The wireless signals are processed by the TV tuner 132 passing signals with one frequency or band frequencies. In a case that the TV signals are in a digital format, the tuned TV signals are demodulated by the TV demodulator 133, thereby generating the second signals S2 in a digital format. Whereas, in another case that the TV signals are in an analog format, the TV decoder 134 performs a demodulation and signal format conversion operation on the tuned TV signals, thereby generating the second signals S2 in a digital format.

For processing both analog signals and digital signals, a hybrid TV tuner is selected as the TV tuner 132 of the TV signal-processing module 13. In addition to TV signals, the wireless signals to be processed by the TV tuner 132 may also include broadcast signals, which are audio signals but not image signals. In a case that broadcast signals are received by the TV signal-processing module 13, the second signals S2 corresponds to a broadcast program. Depending on the type of the wireless signals received by the TV signal-processing module 13, the user may watch the TV program or listen to the broadcast program once the second signals S2 are transmitted to the notebook computer 10.

From the above description, the GPS signal-processing module 12 and the TV signal-processing module 13 are successfully integrated into the same external function expansion device, i.e. the multipurpose peripheral device 1. In the above-described embodiment, the multipurpose peripheral device 1 is implemented by a USB device to be coupled to the bus connection port 101 of the notebook computer 10. As previously described, since the general notebook computer has a limited number of USB ports, only limited USB devices corresponding to the number of USB ports are operable with the notebook computer at the same time in the prior arts. Since two signal-processing modules are integrated into the multipurpose peripheral device 1 according to the present invention, the multipurpose peripheral device 1 can receive and process both GPS signals and TV signals by occupying only one USB port. As a consequence, the number of USB ports may be reduced or the limited number of USB ports will be efficiently utilized.

Moreover, the functions of the antenna 121 and the antenna 131 may be integrated into a single common antenna. The wireless signals received through this common antenna are processed by the corresponding signal-processing module 12 or 13. Accordingly, the circuit layout of the multipurpose peripheral device 1 may be simplified.

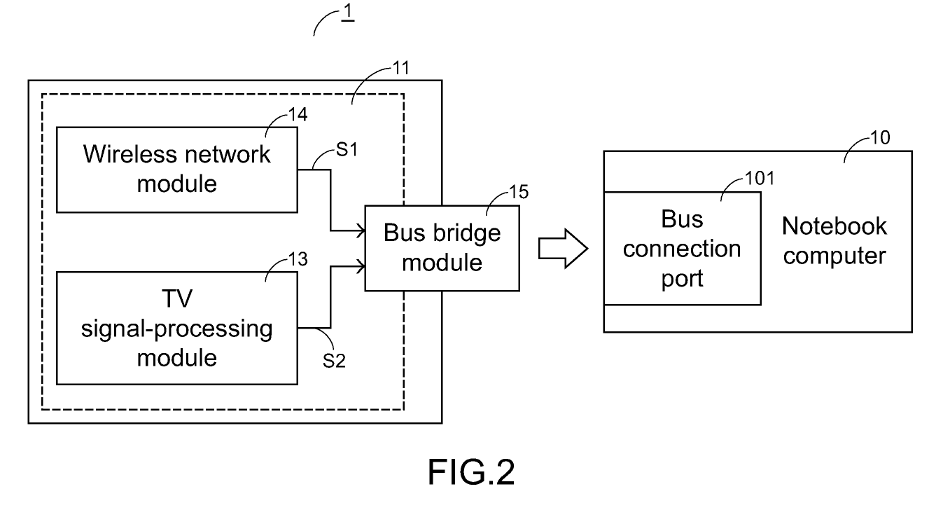

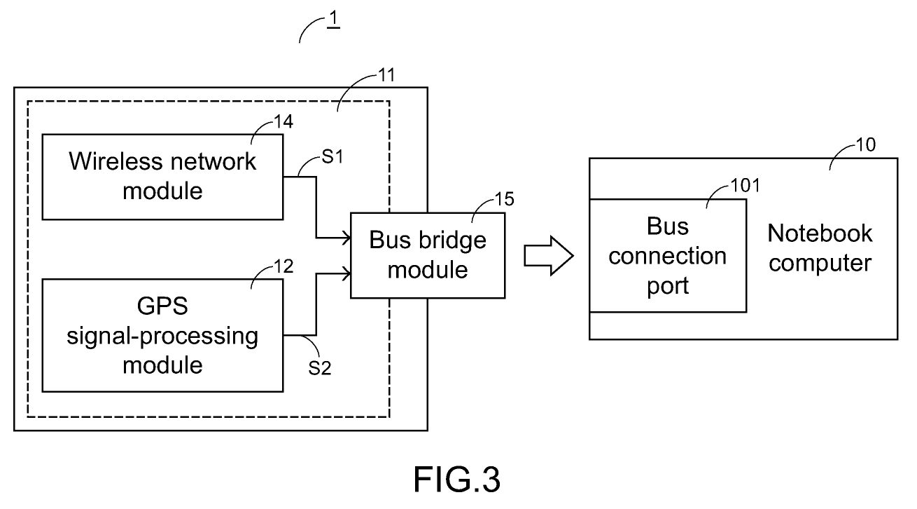

The first preferred embodiment of the present invention is illustrated by referring the multipurpose peripheral device 1 having the GPS signal-processing module 12 and the TV signal-processing module 13. It is noted that, however, those skilled in the art will readily observe that numerous modifications of the multipurpose peripheral device may be made while retaining the teachings of the invention. For example, one or more additional signal-processing modules may be integrated into the multipurpose peripheral device 1. An example of the signal-processing module is a wireless network module, which is operated according to wireless wideband protocols, e.g. 3G or 3.5G or Worldwide Interoperability for Microwave Access (WiMAX). Hereinafter, the second and third embodiments are illustrated with reference to FIGS. 2 and 3. In the second preferred embodiment, a wireless network module and a TV signal-processing module are integrated into the multipurpose peripheral device. In the third preferred embodiment, a wireless network module and a GPS signal-processing module are integrated into the multipurpose peripheral device.

Referring to FIG. 2, a functional block diagram of a multipurpose peripheral device operated with a portable electronic device according to a second preferred embodiment of the present invention is illustrated. In this embodiment, the GPS signal-processing module 12 shown in FIG. 1A is replaced by a wireless network module 14. Whereas, the other components included in the multipurpose peripheral device 1 of FIG. 2 and the operation principles thereof are similar to that shown in FIG. 1A, and are not redundantly described herein. After the multipurpose peripheral device 1 is electrically connected to the bus connection port 101 of the notebook computer 10, the multipurpose peripheral device 1 is operable with the notebook computer 10. Under this circumstance, the user may not only watch TV programs through the notebook computer 10 by receiving TV signals through the TV signal-processing module 13 of the multipurpose peripheral device 1, but also link to the Internet by receiving network data signals through the wireless network module 14.

Referring to FIG. 3, a functional block diagram of a multipurpose peripheral device according to a third preferred embodiment of the present invention is illustrated. In this embodiment, the TV signal-processing module 13 shown in FIG. 1A is replaced by a wireless network module 14. Whereas, the other components included in the multipurpose peripheral device 1 of FIG. 2 and the operation principles thereof are similar to that shown in FIG. 1A, and are not redundantly described herein. After the multipurpose peripheral device 1 is coupled to the bus connection port 101 of the notebook computer 10, the multipurpose peripheral device 1 is operable with the notebook computer 10. Under this circumstance, the user may not only obtain navigation information associated with position, direction and route by receiving GPS signals through the GPS signal-processing module 12, but also link to the Internet by receiving network data signals through the wireless network module 14.

From the above-described embodiments, different signal-processing modules are mounted on the same circuit carrier and integrated into the multipurpose peripheral device, thereby receiving different types of signals. Moreover, via a bus bridge module, the multipurpose peripheral device is communicated and operated with the notebook computer or other portable electronic device. Likewise, the multipurpose peripheral devices of FIG. 2 and FIG. 3 are also implemented by USB devices. Since the two signal-processing modules are integrated into a single multipurpose peripheral device, the limited number of USB ports will be efficiently utilized. Moreover, the individual antennas for each module may be integrated into a single common antenna for receiving wireless signals so as to reduce the layout complexity of the circuit carrier.

In the above-described embodiments, the present invention is illustrated by referring to the multipurpose peripheral device implemented by a USB device and operated with a notebook computer. Nevertheless, the multipurpose peripheral device of the present invention can be applied to other portable electronic devices such as personal digital assistants (PDAs) or smart phones. Furthermore, the bus connection port and the bus bridge module may be designed according to the secure digital input/output (SDIO) protocol. As a consequence, the multipurpose peripheral device of the present invention can be implemented by a SDIO card or other I/O cards.

Moreover, the circuit carrier used in the multipurpose peripheral device is a circuit board. The circuit board may be enclosed by a casing with a specific dimension so as to form a multipurpose peripheral device compatible to a specific bus connection port. For example, in order to be operated with the notebook computer, the multipurpose peripheral device may be designed to have a PCI Express (PCI-E) interface and contain therein at least two types of signal-receiving/processing modules. From the description, person skills in the arts will realize that the multipurpose peripheral devices or the circuit carriers thereof may be designed to have a known interface, for example, USB interface, CardBus interface, PCI-E interface including external Express Card interface and built-in Mini Card interface, Mini PCI interface or other transmission interfaces. Moreover, the function signal-receiving/processing modules may have individual antennas for receiving corresponding wireless signals. Alternatively, the functions of the individual antennas may be integrated into a single common antenna to receive different types of wireless signals.

The present invention is illustrated by referring to the multipurpose peripheral device having two function expansion modules. Nevertheless, the multipurpose peripheral device of the present invention may include more than two function expansion modules. Example of these function expansion modules include but are not limited to a GPS signal-processing module, a TV signal-processing module, a wireless network module and other signal-receiving/processing module such as a Bluetooth module. Accordingly, the problems incurred in the prior arts are successfully solved, and the limited number of the ports of the portable electronic devices can be utilized in a more efficient manner.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multipurpose peripheral device operated with a portable electronic device having a bus connection port, the multipurpose peripheral device comprising:
a circuit carrier;
a GPS signal-processing module disposed on the circuit carrier for receiving and processing a GPS signal, thereby generating a first signal;
a TV signal-processing module disposed on the circuit carrier for receiving and processing a TV signal, thereby generating a second signal; and
a bus bridge module disposed on the circuit carrier and electrically connected to the GPS signal-processing module and the TV signal-processing module for transmitting the first signal and the second signal from the GPS signal-processing module and the TV signal-processing module to the portable electronic device through the bus connection port when the bus bridge module is coupled to the bus connection port.

2. The multipurpose peripheral device according to claim 1 wherein the portable electronic device is one selected from a group consisting of a notebook computer, a personal digital assistant and a smart phone.

3. The multipurpose peripheral device according to claim 1 wherein the bus connection port is one selected from a group consisting of a USB port, a peripheral component interconnect (PCI) port, a PCI Express (PCI-E) port and a secure digital input/output (SDIO) port.

4. The multipurpose peripheral device according to claim 1 further comprising an antenna electrically connected to the GPS signal-processing module and the TV signal-processing module for receiving the GPS signal and the TV signal to be transmitted to the GPS signal-processing module and the TV signal-processing module, respectively.

5. The multipurpose peripheral device according to claim 1 wherein the GPS signal-processing module comprises:
a low noise amplifier for amplifying the GPS signal into an amplified GPS signal;
a GPS tuner for tuning the amplified GPS signal into a tuned GPS signal; and
a baseband demodulator for demodulating the tuned GPS signal, thereby generating the first signal.

6. The multipurpose peripheral device according to claim 1 wherein the GPS signal-processing module further comprises a first antenna for receiving the GPS signal, and the TV signal-processing module further comprises a second antenna for receiving the TV signal.

7. The multipurpose peripheral device according to claim 1 wherein the TV signal-processing module comprises:
a TV tuner for tuning the TV signal into a tuned TV signal;
a TV demodulator for demodulating the tuned TV signal, thereby generating the second signal; and
a TV decoder for performing demodulation and signal format conversion operation on the tuned TV signal, thereby generating the second signal.

8. A multipurpose peripheral device operated with a portable electronic device having a bus connection port, the multipurpose peripheral device comprising:
a circuit carrier;
a wireless network module disposed on the circuit carrier for receiving and processing a network data signal, thereby generating a first signal;
a TV signal-processing module disposed on the circuit carrier for receiving and processing a TV signal, thereby generating a second signal; and
a bus bridge module disposed on the circuit carrier and electrically connected to the wireless network module and the TV signal-processing module for transmitting the first signal and the second signal from the wireless network module and the TV signal-processing module to the portable electronic device through the bus connection port when the bus bridge module is coupled to the bus connection port.

9. The multipurpose peripheral device according to claim 8 wherein the portable electronic device is one selected from a group consisting of a notebook computer, a personal digital assistant and a smart phone.

10. The multipurpose peripheral device according to claim 8 wherein the bus connection port is one selected from a group consisting of a USB port, a PCI port, a PCI-E port and a SDIO port.

11. The multipurpose peripheral device according to claim 8 further comprising an antenna electrically connected to the wireless network module and the TV signal-processing module for receiving the network data signal and the TV signal to be transmitted to the wireless network module and the TV signal-processing module, respectively.

12. The multipurpose peripheral device according to claim 8 wherein the wireless network module further comprises a first antenna for receiving the network data signal, and the TV signal-processing module further comprises a second antenna for receiving the TV signal.

13. The multipurpose peripheral device according to claim 8 wherein the TV signal-processing module comprises:
a TV tuner for tuning the TV signal into a tuned TV signal;
a TV demodulator for demodulating the tuned TV signal, thereby generating the second signal; and
a TV decoder for performing demodulation and signal format conversion operation on the tuned TV signal, thereby generating the second signal.

14. A multipurpose peripheral device operated with a portable electronic device having a bus connection port, the multipurpose peripheral device comprising:
a circuit carrier;
a wireless network module disposed on the circuit carrier for receiving and processing a network data signal, thereby generating a first signal;
a GPS signal-processing module disposed on the circuit carrier for receiving and processing a GPS signal, thereby generating a second signal; and
a bus bridge module disposed on the circuit carrier and electrically connected to the wireless network module and the GPS signal-processing module for transmitting the first signal and the second signal from the wireless network module and the GPS signal-processing module to the portable electronic device through the bus connection port when the bus bridge module is coupled to the bus connection port.

15. The multipurpose peripheral device according to claim 14 wherein the portable electronic device is one selected from a group consisting of a notebook computer, a personal digital assistant and a smart phone.

16. The multipurpose peripheral device according to claim 14 wherein the bus connection port is one selected from a group consisting of a USB port, a PCI port, a PCI-E port and a SDIO port.

17. The multipurpose peripheral device according to claim 14 further comprising an antenna electrically connected to the wireless network module and the GPS signal-processing module for receiving the network data signal and the GPS signal to be transmitted to the wireless network module and the GPS signal-processing module, respectively.

18. The multipurpose peripheral device according to claim 14 wherein the wireless network module further comprises a first antenna for receiving the network data signal, and the GPS signal-processing module further comprises a second antenna for receiving the GPS signal.

19. The multipurpose peripheral device according to claim 14 wherein the GPS signal-processing module comprises:
a low noise amplifier for amplifying the GPS signal into an amplified GPS signal;
a GPS tuner for tuning the amplified GPS signal into a tuned GPS signal; and
a baseband demodulator for demodulating the tuned GPS signal, thereby generating the first signal.
